(19) United States
(12) Patent Application Publication
(10) Pub. No.: US 2008/0080432 A1
(43) Pub. Date: Apr. 3, 2008

(54) Carrying Mobile Station Specific Information in the Reverse Access Channel in a Wireless Communications System

(76) Inventors: Jianmin Lu, San Diego, CA (US); Yunsong Yang, San Diego, CA (US); Zhigang Rong, San Diego, CA (US)

Correspondence Address: SLATER & MATSIL, L.L.P., 17950 PRESTON RD, SUITE 1000, DALLAS, TX, 75252-5793, US

(21) Appl. No.: 11/849,776

(22) Filed: Sep. 4, 2007

Related U.S. Application Data
(60) Provisional application No. 60/827,850, filed on Oct. 2, 2006.
(60) Provisional application No. 60/867,790, filed on Nov. 29, 2006.

(51) Int. Cl. H04B 7/216

(52) U.S. Cl. 370/335; 370/209

(57) ABSTRACT

Two types of access probe messages are defined: a first when a mobile station has not yet been assigned a media access code index (MAC ID), and a second when a mobile station already has a MAC ID assigned by the base stations in the active set. Base stations can differentiate between the first and second types of access probes according to the scrambling sequence used. In the second type, while different MAC IDs are used by each of the mobile stations in the sector, they are all scrambled according to a similar scrambling sequence defined specifically for these second types of access probes. The rake receivers used in such networks are configured to repeat the rake finger processing after CP removal, DFT, de-channelizing, and IDFT, thereby reducing their complexity.

This application claims the benefit of U.S. Provisional Application No. 60/827,850, filed on Oct. 2, 2006, entitled “Method and Apparatus for Access Based Handoff in a Wireless Communications System,” and of U.S. Provisional Application No. 60/867,790, filed on Nov. 29, 2006, entitled “A Method for Carrying Mobile Station Specific Information in the Reverse Access Channel in a Wireless Communications System,” which applications are hereby incorporated herein by reference.

### TECHNICAL FIELD

The present invention relates, in general, to a wireless communications system, and, more particularly, to carrying mobile station specific information through the reverse access channel in a wireless communications system.

### BACKGROUND

The 3rd Generation Partnership Project 2 (3GPP2) is a collaboration between telecommunications associations to make a globally applicable third generation (3G) mobile phone system specification within the scope of the International Telecommunication Union's (ITU's) IMT-2000 project. In practice, 3GPP2 is the standardization group for CDMA2000, which is the set of 3G standards based on earlier second generation (2G) code division multiplex algorithm (CDMA) technology.

In the currently proposed air interface evolution (AIE) of the loosely backward compatible (LBC) mode defined by 3GPP2, a mobile station or access terminal (AT) uses the reverse access channel to initiate a call by sending a first type of access probe with an access sequence randomly selected from a pool of access sequences and scrambled by the first scrambling sequence. In this case, the access network does not know the identity of the accessing mobile station from the received access probe. Instead, the mobile station will supply its identity information during the binding process after the access network detects the access probe and grants the reverse link channel to the mobile station. This is the first type of access probe generally used by mobile stations.

In addition to this case where the mobile station is initiating a call, as described above, there are other cases in which a mobile station sends a second type of access probe on the reverse access channel. This second type of access probe is used when the access networks already know the identity of the mobile stations, typically in the form of a media access control (MAC) index (MAC ID), which is assigned by the access network to represent the identity of a mobile station in a sector. These situations may occur, for example, during the access-based hand-off between sectors or when a mobile station that is in a semi-connected state tries to exit the semi-connected state.

Current development in orthogonal frequency division multiplex (OFDM) networks defines this additional “semi-connected state.” In this state, the mobile station has already established communication with the access network base stations, but, in order to save battery power during low activity periods, the mobile station enters into a semi-connected state. The base station maintains the connection information on the semi-connected mobile station including much of the MAC layer resources, such as the MAC ID, but releases the physical (PHY) layer resources assigned to that mobile station and assigns them to other active mobile stations. Therefore, because no PHY layer resources are assigned to the semi-connected mobile station, it relies on the reverse access channel to signal the base station that it intends to leave that state.

Additionally, the second type of access probe may find use in hand-off procedures, where a mobile station changes connection from one base station to another in the active set of base stations in the access network. Previously, when a mobile station desired to hand-off to another base station, it measured the signal quality of each of the base stations in the active set and transmitted the hand-off request with the signal quality and strength measurements to its anchor base station (i.e., the base station to which it was currently connected). This base station then performs calculations using the signal strength and quality measurements received from the mobile station and determines if the mobile station can, in fact, make the hand-off. This mechanism between the anchor base station and the mobile station generally occurs over handshaking between the two entities.

In OFDM networks, the base stations prefer to receive all of the mobile stations at once, so that all of the mobile stations are synchronized on the reverse link, also known as the uplink. This synchronization is useful to prevent energy leakage or OFDM symbol interference, when the base stations are performing discrete Fourier Transformation (DFT) or the fast implementation process of DFT known as fast Fourier Transformation (FFT). DFT and FFT are used interchangeably in the remainder of this disclosure without the intent of departing from the spirit and scope of the present invention. Thus, when contemplating a hand-off to a new base station in an OFDM network, the industry has evolved to combine timing information with the hand-off access probe in the mobile station, such that when the target base station receives the hand-off access probe, it also detects the timing offset, if there is one, from the requesting mobile station, such that when the hand-off access is acknowledged, the mobile station receives its synchronizing delay information from the target base station in the acknowledgement, thus, saving time and overhead in the hand-off process. Because the mobile station's MAC ID is already known in the hand-off procedure, the type of access probe used is also of the second type.

The commonality between the two example situations where the mobile station uses an access probe for exiting a semi-connected state and for making a hand-off to a new base station is that the target base station has already assigned a MAC ID to the mobile station. In maintaining the active set of base stations for a particular mobile station, the anchor base station maintains the information for all of the base stations on the list as those base stations are added. When a new base station is added to the active set, the anchor base station unicasts, in a hand-off message, all of the information about that new base station, including the MAC ID that is assigned by the new base station to represent the identity of this mobile station in the new base station. Thus, each mobile station knows what its MAC ID is for any target base station in the active set. Therefore, any situation in which the mobile station's MAC ID is already known may use this second type of access probe. The specific examples of the semi-connected station and hand-off situation are merely two examples of where this second type of access probe may arise.

Referring to FIG. 1, a block diagram is illustrated that represents the structure of regular access channel 10. Access sequence ID 100 is typically used by access sequence generator 101 to generate a 1024-bit long access sequence. The output access sequence from access sequence generator 101 is then usually interleaved by interleaver 102. The output interleaved sequence from interleaver 102 may then be scrambled by scrambler 103 using a scrambling sequence from scrambling sequence generator 105. A pseudo-random scrambling sequence is usually generated by scrambling sequence generator 105 using a shift register structure which has an initial state given by scrambling seed 104. Scrambling seed 104 is typically a combination of a certain sector identity, such as pilot phase, and a certain time value, such as the frame index, so that the scrambling sequences are different for different neighboring sectors and keep changing. Usually by the time the mobile station needs to send an access probe, the mobile station should already have acquired the knowledge of the sector ID and frame index.

The scrambled signal may be modulated by modulator 106 and then transformed at discrete Fourier transformation (DFT) element 107. This transformed signal is usually mapped onto the appropriate frequency subcarriers by channelizer 108. The output sequence may then be transformed again by inverse discrete Fourier Transformation (IDFT) element 109. Cyclic prefix (CP) 110 may further be inserted in front of the IDFT-transformed sequence to form the time domain baseband signal. This time domain signal may be further filtered by pulse-shaping filter 111 to reduce the out-of-band emission and clipped by clipper 112 to reduce the peak-to-average ratio before being modulated by modulator 113 onto the radio frequency (RF) carrier for over-the-air transmission.

FIG. 2 is a flow diagram illustrating typical access-based hand-off process 20. Link 200 represents the on-going traffic between the AT and the source base station (also known as the Source Access Point or Source AP) before hand-off. When a new sector (Target AP) is added into the active set, Source AP obtains the necessary information from Target AP. Link 201 represents Source AP transmitting the MAC ID that is assigned to the AT by Target AP to the individual AT (i.e., in unicast transmission). If AT determines to conduct an access-based hand-off to Target AP, it sends an access probe over link 202 to Target AP. Target AP may then grant the hand-off by sending an access grant message in the shared control channel (SCCH) over link 203. Upon receiving the access grant message, AT regards the hand-off as complete. The new traffic is then conveyed between AT and Target AP over link 204.

In order to deal with the second type of access probe, it has been proposed that, since the mobile stations already have a MAC ID assigned, the scrambling code used to scramble the access probe message should be based on the mobile station's MAC ID. However, there are problems with this type of proposal because it greatly increases use of network resources for de-scrambling these messages. For example, there may be a thousand mobile stations in one access network. That corresponds to a thousand different MAC IDs and a thousand different ways of scrambling the access probe. If a base station needs to de-scramble such an access probe, it will typically begin systematically attempting to de-scramble this probe using each known MAC ID in the access network until the right combination is found. While this solution is readily available, the cost in network resources and the delay which would come from this excessive processing is unacceptable.

Because CDMA and, more specifically, OFDMA networks, provides multipath rejection capabilities, rake receivers are often used in the transmission of communications signals between the mobile stations and base stations. FIG. 3 is a block diagram illustrating typical transmitting/receiving channel structure 30 for an OFDMA-based communications system. Traditional OFDMA-based communications systems can typically transmit the modulated and encoded data symbols, modulated and encoded at modulation/encoding modules 300-1 and 300-2, directly on the frequency subcarriers, such as Channel 1 (Ch. 1) and Channel 2 (Ch. 2). The modulated and encoded data symbols, modulated and encoded at modulation/encoding module 300-N, may also be transmitted in the time domain, such as Channel N (Ch. N), by performing a DFT operation with a first FFT size at DFT module 302 after converting the signal from serial to parallel at S/P 301-N and then mapping the output from DFT module 302 to IDFT module 304 through channelization element 304, where IDFT module 305 usually has a second FFT size that is larger than the first FFT size. The latter technique, by which Ch. N is transmitted, is also referred to as DFT-OFDMA.

DFT-OFDMA may preserve certain time domain characteristics of the original modulated and encoded data symbols, such as a low peak-to-average power ratio and the like. Therefore, DFT-OFDMA is often used for control channels, while the pure OFDMA is often used for data channels. These two types of channels may be multiplexed at channelization element 303 using the same frame. This is possible because channelization element 303 generally uses orthogonal frequency subcarriers for each channel.

After transforming the channelized output at IDFT module 304, the parallel output signals are re-serialized and the cyclic prefixes (CPs) are inserted at P/S and CP insertion module 305 to form the baseband signal. The baseband signal is then modulated onto the radio frequency (RF) carrier for transmission over channel 306. White noise 307 is then added to the received signal. After the received RF signal is down-converted to the baseband signal, CP removal and S/P module 308 first removes the CP from the received baseband signal and then converts the serial CP-removed baseband signal to parallel streams for a DFT operation with the second FFT size performed by DFT module 309. DFT module 309 converts the time domain signal into the frequency domain for de-channelization element 310 to separate into multiple channels based on the frequency sub-carriers they occupy. The output signals for Ch. 1 and Ch. 2, which are transmitted using a pure OFDMA technique, are further re-serialized by P/S modules 311-1 and 311-2, then demodulated and decoded by demodulation and decoding modules 313-1 and 313-2, respectively. The output signals from de-channelization element 310 for Ch. N, which are transmitted using the DFT-OFDMA technique, are further converted back to the time domain by IDFT module 312 using the first FFT size and re-serialized by P/S module 313-N. Demodulation and decoding module 311-N then performs the demodulation and decoding on the Ch. N signal to recover the information bits.

Rake receivers are a well known technique used to combat the multipath effect in CDMA systems. In CDMA networks, multiple delayed versions of the incoming CDMA signals are usually correlated with a known signal while the output signals are typically detected and combined based on a certain combining algorithm. Because the data symbols are effectively transmitted in the time domain when using the DFT-OFDMA technique, utilizing the rake receiver to take advantage of the multipath may improve the decoding performance. However, applying the CDMA rake receiver structure to DFT-OFDMA would require the rake receiver to first receive multiple delayed versions of the incoming signal, and then, for each delayed version, perform CP removal and serial-to-parallel (S/P) conversion (as in element 308 of FIG. 3), DFT (element 309 of FIG. 3), de-channelization (element 310 of FIG. 3), IDFT (element 312 of FIG. 3), and the like, before signal combining can take place. Therefore, the number of computations is multiplied by the size of the search window of the rake receiver. As DFT and IDFT processes, such as those illustrated in elements 310 and 312 of FIG. 3, tend to consume a large number of computations, the costs in computational resources is great.

### SUMMARY OF THE INVENTION

Representative embodiments of the present invention provide methods for carrying MAC ID information in an access probe so that an access network can determine the identity a the mobile station using a received access probe without using the binding process.

Additional representative embodiments of the present invention provide methods for carrying mobile identity information and other mobile specific information in a second type of access probe by assigning a MAC ID to the mobile station. This access sequence may have a first portion related to the MAC ID assigned by the target sector, and a second portion that includes some mobile station specific information, such as the measured target sector forward pilot level and/or mobile request level. The other transmission parameters of the access probe, such as the access time slots, the scrambling sequence used on the reverse access channel, or the interleaving pattern used on the reverse access channel, and the like, may be determined by the second portion of the MAC ID if the second portion of the MAC ID is not included in the access sequence ID. The MAC ID used in the second type of access probe can be the regular MAC ID that is used to identify the mobile station in the access network for all purposes, or it can be related to the regular MAC ID, with potentially a shorter length, that may be used to identify the mobile station in the access network for the purpose of sending the second type of access probe.

Additional representative embodiments of the present invention also provide methods for scrambling an access grant message according to the type of the access probe the access grant message is sent in response to. In operation, these methods scramble the first type of access probe using a first scrambling sequence initiated by the accessing mobile station. The accessing mobile station uses a second scrambling sequence in order to scramble the second type of access probe. The access network/base station can then differentiate the type of access probe by the particular scrambling sequence applied thereto. In situations dealing with the first type of access probe, the access network/base station provides assignment of the mobile station's MAC ID and provides reverse link timing information in the access grant message to the mobile station. It scrambles this access grant message using the scrambling sequence generated from the access sequence ID of the first type of access probe. In situations dealing with the second type of access probe, the access network/base station may provide reverse link timing information and copy the MAC ID detected from the second type of access probe into the MAC ID field of the access grant message. It scrambles this access grant message for the second type of access probe using a scrambling sequence that is different from any scrambling sequence used in response to the first type of access probe.

Representative embodiments of the present invention are directed to methods executed by a mobile station in a wireless network. The methods start with scrambling a first type of access probe using a first scrambling sequence, the first type of access probe generated without a media access code index (MAC ID) assigned to the mobile station by a base station, scrambling a second type of access probe using a second scrambling sequence, where the second scrambling sequence is different from the first scrambling sequence, and where the second scrambling sequence is assigned by the wireless network to be associated with the second type of access probe, and then transmitting the scrambled second type of access probe to the base station via a reverse access channel.

Additional representative embodiments of the present invention also are directed to methods executed by one or more base stations in a wireless network. The methods begin by receiving an access probe via a reverse access channel from one or more mobile stations, analyzing a scrambling sequence of the access probe. Responsive to the analyzing, the access probe is determined to be a second type from a known one of the one or more mobile stations based on the scrambling sequence being associated with the second type by the wireless network. An access grant message is generated responding to the access probe and scrambled with a second access grant scrambling sequence designated by the wireless network for the second type of access probe.

Still further representative embodiments of the present invention also are directed to wireless networks that include one or more base stations and a plurality of mobile stations connected to the one or more base stations. There is a reverse access channel that facilitates communication initiated by ones of the plurality of mobile stations and one of the one or more base stations. There is also a second type access probe message generated by one of the plurality of mobile stations to communicate with one of an active set of the one or more base stations, where each base station of the active set has already assigned a MAC ID to the one or the plurality of mobile stations. A second type scrambling sequence is assigned by the wireless network to scramble the second type access probe message. A second type access grant message is generated by one of the one or more base stations, in response to the second type access probe message. This second type of access grant message is scrambled according to a second access grant scrambling sequence.

Additional representative embodiments of the present invention also are directed to computer program products having a computer readable medium with computer program logic recorded thereon. The computer program products include code for scrambling a first type of access probe using a first scrambling sequence, the first type of access probe generated without a MAC ID assigned to a mobile station by a base station in a wireless network, code for scrambling a second type of access probe using a second scrambling sequence, where the second scrambling sequence is different from the first scrambling sequence, and where the second scrambling sequence is assigned by the wireless network to be associated with the second type of access probe, and code for transmitting the scrambled second type of access probe to the base station via a reverse access channel.

Further representative embodiments of the present invention also are directed to computer program products having a computer readable medium with computer program logic recorded thereon. The computer program products include code for receiving an access probe by one or more base stations via a reverse access channel from one or more mobile stations, and code for analyzing a scrambling sequence of the access probe. In response to the results of the analysis, there is also code for determining that the access probe is a second type from a known one of the one or more mobile stations based on the scrambling sequence being associated with the second type by a wireless network. There is also code for generating an access grant message responding to the access probe and code for scrambling the access grant message with a second access grant scrambling sequence reserved by the wireless network for the second type of access probe.

Additional representative embodiments of the present invention also are directed to methods for a rake receiver that include removing the cyclic prefix (CP) from an incoming baseband signal, converting the CP-removed baseband signal from serial to parallel format, performing DFT to convert the parallel signal from time domain to frequency domain, de-channelizing the converted signal, separating data channel signals, and control channel signals based on the frequency subcarriers that each channel occupies, and performing IDFT to re-convert the control channel signals from frequency domain to time domain. A plurality of cyclic shifted versions of the reconverted control channel signals are generated after the removing, converting, de-channelizing, and reconverting. Each of the plurality of cyclic shifted signals is then correlated to a plurality of Walsh codes, after which the correlation energies of a plurality of cyclic shifted signals with each Walsh code of a plurality of Walsh codes are combined. Finally, one or more Walsh code indexes are determined to represent the transmitted information bits based on the combined correlation energy for each Walsh code of a plurality of Walsh codes.

Additional representative embodiments of the present invention also are directed to rake receivers that include a discrete Fourier Transformation (DFT) module at an input to the rake receiver, a channel separator connected to the DFT module to separate data channel signals and control channel signals from an incoming baseband signal, an inverse DFT (IDFT) module connected to an output of the channel separator, a cyclic shift rotator connected to the IDFT module for generating a plurality of cyclic shifted versions of the control channel signals, a plurality of correlators connected to the cyclic shift rotator, where each of the plurality of cyclic shifted versions is processed through a corresponding one of the plurality of correlators, and an energy detector connected to each of the plurality of correlators, where the energy detector combines the plurality of cyclic shifted versions after correlation and determines the detection results.

Additional representative embodiments of the present invention also are directed to computer program products having a computer readable medium with computer program logic recorded thereon. The computer program products include code for removing one or more cyclic prefixes (CPs) from an incoming baseband signal, code for converting the CP-removed baseband signal from serial to parallel format, code for performing DFT to convert the parallel signal from time domain to frequency domain, code for de-channelizing the converted signal and separating data channel signals and control channel signals based on the frequency subcarriers that each channel occupies, and code for performing IDFT to reconvert the control channel signals from frequency domain to time domain. There is also code for generating a plurality of cyclic shifted versions of the reconverted control channel signals after execution of the code for removing, the code for converting, the and code for de-channelizing, and the code for reconverting. There is also code for correlating each of the plurality of cyclic shifted signals to a plurality of Walsh codes, code for combining the correlation energies of the plurality of cyclic shifted signals for each Walsh code of a plurality of Walsh codes, code for determining one or more Walsh code indexes to represent the transmitted information bits based on the combined correlation energy for each Walsh code of a plurality of Walsh codes.

### BRIEF DESCRIPTION OF THE DRAWINGS

FIG. 1 illustrates an exemplary channel structure of the regular access channel for LBC mode in 3GPP2;

FIG. 2 illustrates a flow diagram of the typical access-based hand-off process;

FIG. 3 illustrates a block diagram of a transmitting and receiving process for an OFDMA-based communications system;

FIG. 4 illustrates a flow diagram of an access-based hand-off configured according to one embodiment of the present invention;

FIG. 5 illustrates a block diagram of a DFT-OFDMA demodulation module with an improved rake receiver structure configured according to one embodiment of the present invention;

FIG. 6 illustrates an example access sequence ID configured according to one embodiment of the present invention;

FIG. 7 illustrates an exemplary channel structure of a forward shared control channel;

FIG. 8 is a flowchart illustrating example steps executed to implement one embodiment of the present invention;

FIG. 9 is a flowchart illustrating example steps executed to implement one embodiment of the present invention; and

FIG. 10 illustrates an example computer system configured to operate a system according to one embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The present invention provides a unique method and system for carrying mobile station specific information on the reverse access channel in a wireless communications system. Specific examples of components, signals, messages, protocols, and arrangements are described below to simplify the present disclosure. These are, of course, merely examples and are not intended to limit the scope of the invention from that scope defined in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

Turning now to FIG. 4, a flow diagram is illustrated depicting an example of access-based hand-off process 40 configured according to one embodiment of the present invention. Link 400 represents the traffic between AT and Source AP. When a sector or base station (Target AP) is added into the active set of the access network, the hand-off MAC ID assigned to AT by Target AP is transmitted over link 401. As AT determines to conduct an access-based hand-off to Target AP, AT will send a special hand-off access probe (an access probe of the second type) to Target AP over link 402. If appropriate, Target AP will grant the hand-off by sending a special hand-off access grant message in the shared control channel (SCCH) using link 403. This hand-off access grant message includes the regular MAC ID, which has already been assigned by Target AP when Target AP is added to the active set, and the timing adjustments for uplink synchronization. Upon receiving the special hand-off access grant message, AT regards the hand-off as complete. The traffic will then flow between AT and Target AP thereafter over link 404.

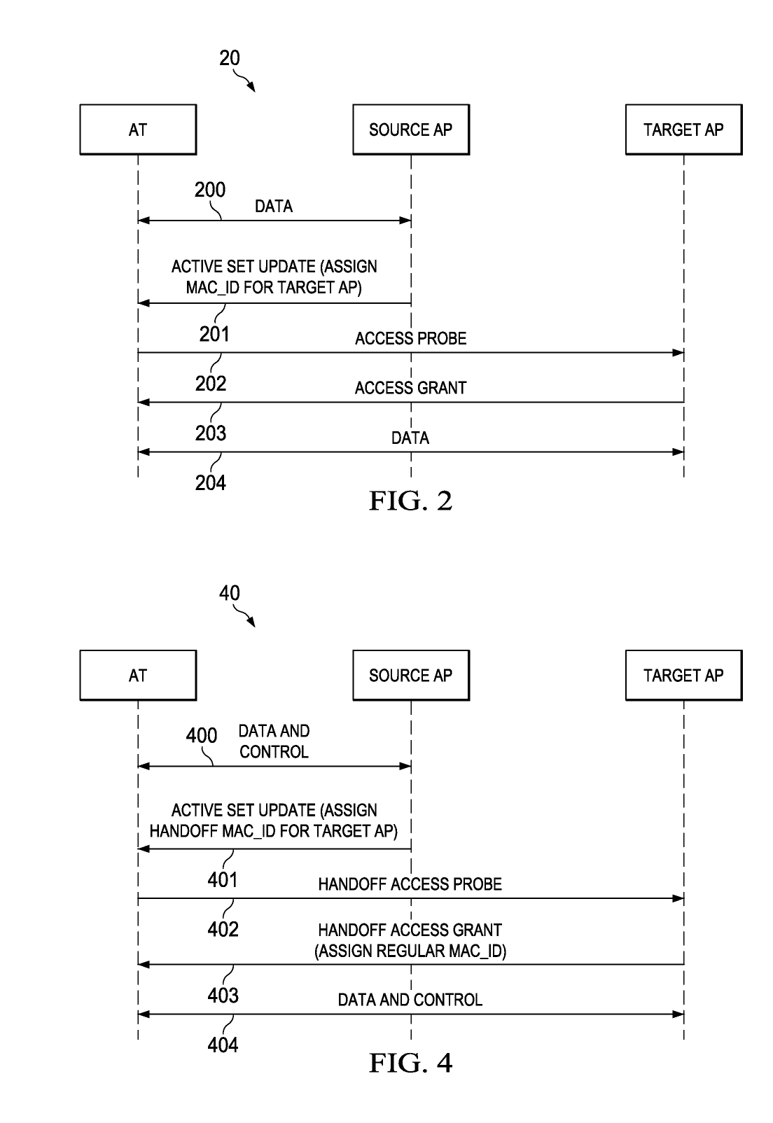

It should be noted that the difference between the access-based hand-off process in FIGS. 2 and 4 revolves around the hand-off access probe transmitted by the mobile station/AT and the special hand-off grant message transmitted back to the mobile station/AT by Target AP.

According to one aspect of the present invention, the second type of access probe may be used, in general, by a mobile station that already has a MAC ID assigned by the access network. For example, if the target sector is asynchronous to the current serving sector, the AT may send the second type of access probe as the indication of a hand-off request. In another example, a synchronous base station or sector may need to determine the timing information on an uplink from a particular mobile station. The mobile station may then send the second type of access probe as a timing reference signal for the base station to measure the timing of the received signal in order to determine the timing adjustment that the mobile station should perform on its transmitter. In yet another example, a mobile station in the semi-connected state may use the second type of access probe to resume communications with the access network or in order to enter an idle state. In these scenarios, the mobile station has already been assigned a MAC ID.

The mobile station scrambles the second type of access probes using a second scrambling sequence that is different from a first scrambling sequence used when sending the first type of access probe. However, the second scrambling sequence is common for all access probes of the second type. The access network may then preferably recognize the identity of the mobile station from the received second type of access probe without going through the banding process, therefore eliminating the overhead and delay associated with the banding process, which is a communications process where a mobile station informs the access network of a more permanent identity of the mobile station, such as, for example, the 128-bit Unicast Access Terminal Identity (UATI). Because all second type access probes use one common scrambling code with different access sequences, the complexity of the receiver is reduced.

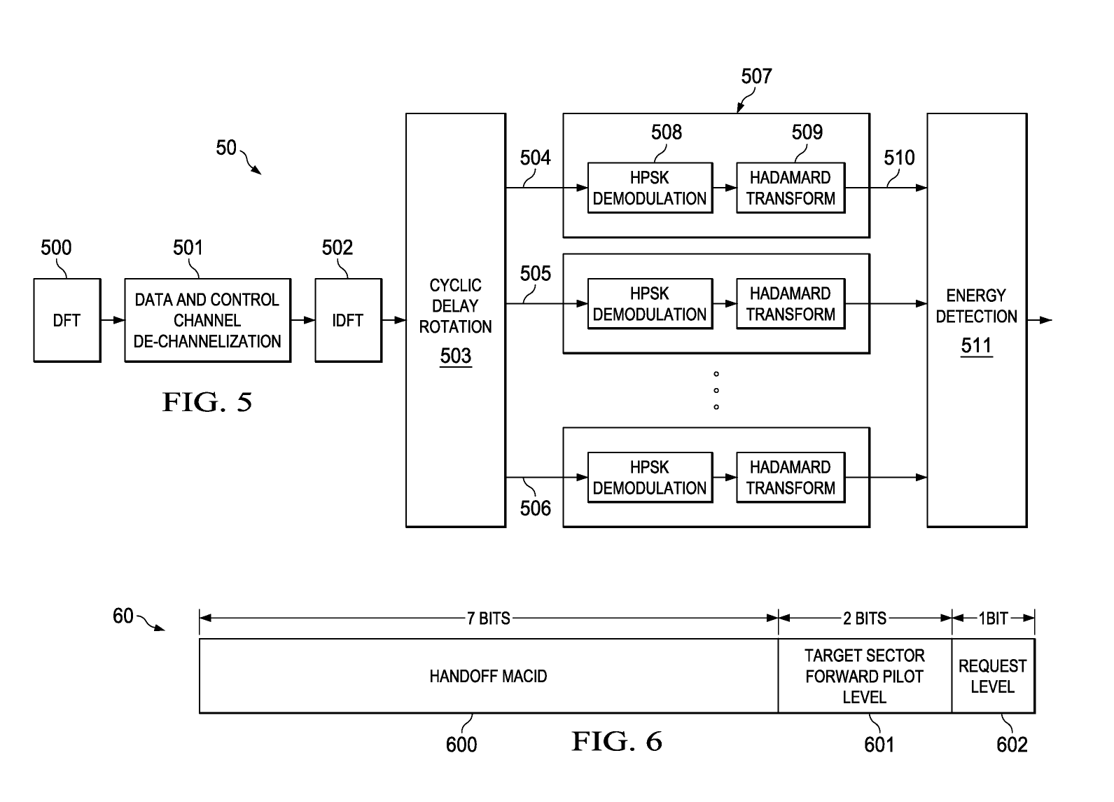

FIG. 5 is a block diagram illustrating DFT-OFDMA rake receiver 50 configured according to one embodiment of the present invention. The incoming baseband signal is first converted to frequency domain by a DFT operation by DFT module 500. The data and control channel de-channelization element 501 separates the signals for the data channel and the control channel in the frequency domain. The output for the control channel, which is transmitted based on the DFT-OFDMA technique, is transformed into the time domain by inverse discrete Fourier Transformation (IDFT) element 502. Cyclic shift rotator 503 produces multiple cyclic shifted versions of the transformed control signal. Each process length comprises one OFDM symbol. The delay offset between the first version (processed through path 504) and the last version (processed through path 506) is also known as the searching window size.

Multiple OFDM symbols may each be fed into correlator 507. Correlator 507, also known as a rake finger, corresponds to one cyclic shifted version of the signal, which comprises HPSK demodulator/descrambler 508 and Hadamard transformer 509. Here the Hadamard transformer acts like a correlator with various Walsh sequences, which are used as the access sequence. The Walsh sequences of the various embodiments of the present invention are orthogonal to one another, thus, an optimal receiver just calculates the matrix product of the received Walsh sequence and the Hadamard matrix in order to correlate the received sequence with each Walsh code. Output 510 of Hadamard transformer 509 is the correlation of the cyclic shifted signal with a variety of Walsh sequences. Energy detection module 511 collects all the correlation values (such as the energy values of each output element of the matrix product or the signal-to-noise ratio values of each output element of the matrix product) from all of the rake fingers for each Walsh sequence and makes the determination of which Walsh sequence(s) is/are detected.

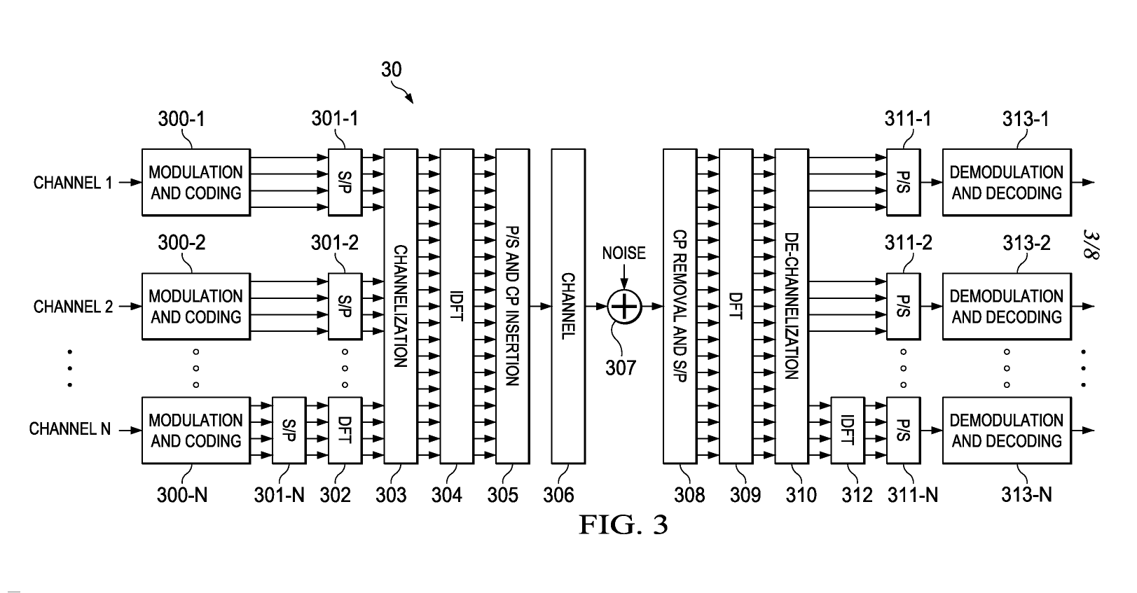

Referring back to FIG. 3, a traditional rake receiver would generate multiple delayed versions of a received signal before CP removal and S/P module 308. For each of the multiple delayed versions, the processing of CP removal and S/P module 308 through demodulating and decoding module 313-N are to be performed before the outputs can be combined. In contrast, in operation of the various embodiments of the present invention, the multiple delayed versions of a received signal are generated after IDFT module 312 by cyclic rotator 503 (FIG. 5). Therefore, the processing performed between CP removal and S/P module 308 through IDFT module 312 (FIG. 3) are performed only once for all delayed versions while descrambling/demodulating 508 and transforming 509 are performed for each of the multiple delayed versions before the outputs are combined. Therefore, the improved rake receiver dramatically reduces the complexity of DFT-OFDMA rake receivers while maintaining the benefit of traditional rake receivers.

In various circumstances that call for the second type of access probe, there is no dedicated reverse channel targeting the new sector or base station for a particular mobile station before the hand-off request. Therefore, while the regular MAC ID may be used, it is not necessary to use it. In one embodiment of the present invention, a special hand-off MAC ID associated with the new sector or base station is assigned to the AT. In this particular embodiment, the hand-off MAC ID is different from the regular MAC ID so that this AT will not consume the regular MAC ID resource before the hand-off request. This hand-off MAC ID is assigned by the new sector. However, if there is no air interface between the AT and this new sector, the assignment message may be transmitted by the current anchor sector. The communications between the current anchor sector and the new sector is typically implemented via the backhaul.

In the LBC mode of 3GPP2, the regular MAC ID is proposed as being anywhere between 9-11 bits. Because the number of hand-off users is likely to be smaller than that of the non-hand-off users, a shorter hand-off MAC ID, for example, 7 bits, may be used. In one embodiment of the present invention, a particular hand-off MAC ID is assigned by each sector in the active set that may be accessed through access-based hand-off.

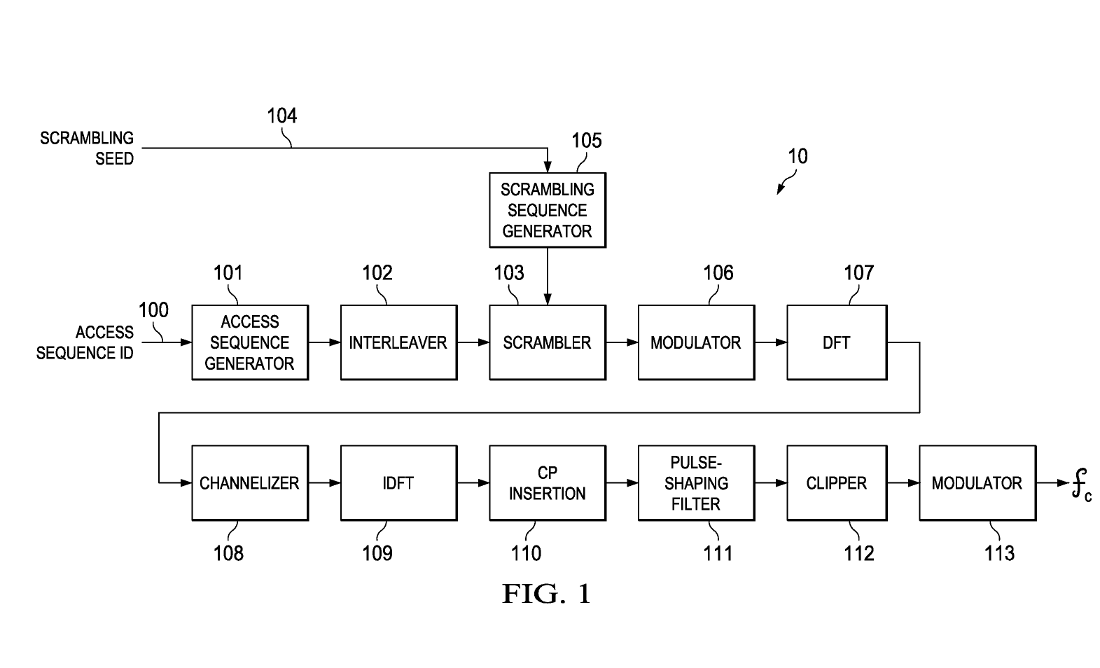

The modulation scheme of the second type of access probe is similar to the regular access probe, as illustrated in FIGS. 1 and 3. In various embodiments of the present invention, the AT chooses the access sequence ID based on the MAC ID, as well as the target sector forward link strength, the request level, and the like.

FIG. 6 is a block diagram illustrating example access sequence ID 60 configured according to one embodiment of the present invention. Access sequence ID 60 comprises 7-bit MAC ID 600, 2-bit target sector forward link strength 601, and 1-bit request level 602. Target sector forward link strength 601 may comprise the forward pilot level strength as measured by the mobile station. Request level 602 may be used to indicate the buffer level, priority level, quality of service (QoS) of the application of the mobile station, or in the case of exiting the semi-connected state, this bit may be used to indicate a request to enter the active state or to enter the idle state.

It should be noted that additional and/or alternative embodiments of the present invention may employ numerous variations and alterations in selection of the access sequence ID for the second type of access probe without departing from the spirit of the present invention. For example, the access sequence ID for the second type of access probe may also be indicated by the access network.

It should further be noted that in various additional and/or alternative embodiments of the present invention, the MAC ID used for the second type of access probe in hand-off or other circumstances may comprise the regular MAC ID, a shortened version of the regular MAC ID, the special hand-off MAC ID defined above, some kind of derivative of the regular MAC ID, and the like. The present invention is not limited to any one method for representing the MAC ID.

The scrambling code used for the scrambling process, e.g., by hybrid phase shift keying (HPSK) modulation of the hand-off access probe, as well as the other access probes of the second type, should be distinguishable from the other reverse channels including the regular access channel for the first type of access probe so that the access network may know the purpose of hand-off. The seed of the scrambling code may be determined by the pilot phase of the target sector, which represents the identity of the sector in the network, the timing information, such as the frame offset in the superframe, and the access probe type.

In the currently proposed AIE LBC system, when the access network detects an access probe, the access network sends an access grant message on the forward shared control channel (F-SCCH) to assign a MAC ID to the mobile station and to provide reverse timing information for the accessing mobile station to adjust its reverse link transmission timing. The access network then sends a reverse link assignment message to provide a dedicated reverse link resource for the accessing mobile station to indicate its identity in the binding process and to indicate intention of the access attempt in the connection setup process.

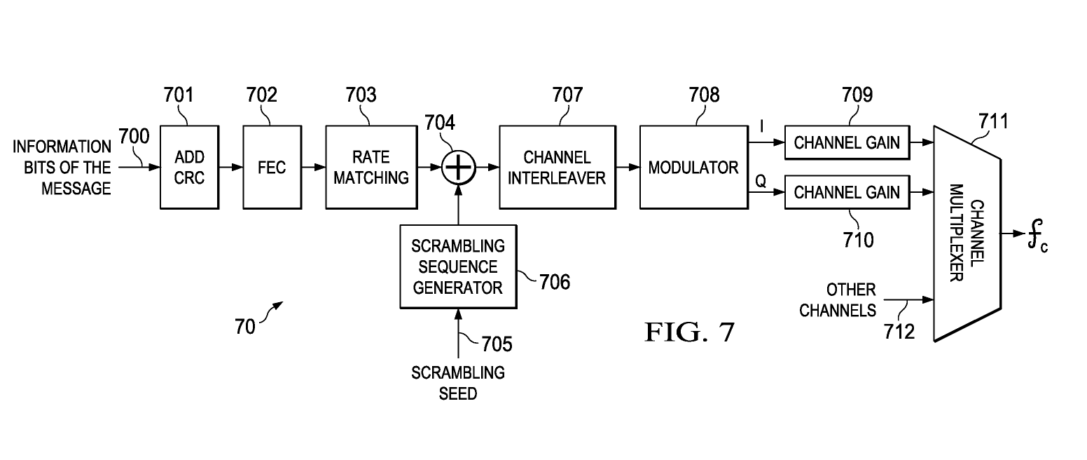

FIG. 7 is a block diagram illustrating channel structure 70 of the F-SCCH. Cyclic Redundant Check (CRC) bits are first added to information bits of the message 700 by CRC element 701. Forward error correction (FEC) encoder 702 adds FEC coding to the output sequence of CRC element 701. Rate matching element 703 repeats and/or punctures the encoded bits from FEC encoder 702 in order to match the rate on the F-SSCH to a certain fixed rate. Scrambler 704 then scrambles the output sequence from rate matching element 703 with a scrambling sequence that is generated by scrambling sequence generator 706 with the input of scrambling seed 705. The scrambled sequence is interleaved by channel interleaver 707 and then modulated by modulator 708. The in-phase (I) and quadrature (Q) outputs of modulator 708 are gain-controlled by channel gain elements 709 and 710, respectively. The output complex signal is then multiplexed with other channels 712 by channel multiplexer (i.e., channelizer) 711. Additional functionality after channel multiplexer 711 of channel structure 70, such as those functions represented in elements 304, 305, and the like, of FIG. 3, are not repeated in FIG. 7.

In the currently proposed AIE LBC system, because the access network does not know the identity of the accessing mobile station from the received access probe, the access network addresses the accessing mobile station in the access grant message by scrambling the encoded sequence of this message with a scrambling sequence that is generated from the access sequence ID detected from the access probe.

In the previous sections, a method is described for the access network to obtain the identity of the accessing mobile station that sends the second type of access probe, for example, to indicate the request to hand-off to an asynchronous sector, to exit the semi-connected state, to provide timing information to a synchronous sector, and the like. In this case, the access network still needs to send the access grant message, at least to provide the reverse link timing information as the mobile station needs this information to adjust its reverse link transmission timing. If the access network scrambles this access grant message with the scrambling sequence that is generated from the access sequence ID detected from a second type of access probe sent by a first accessing mobile station, this access grant message may be mistakenly received by a second mobile station that is initiating a call and randomly selects an access sequence (from the pool of access sequences) that happens to correspond to the same access sequence ID used by the first mobile station. This second mobile station will interpret this access grant message as if the message is directed to it, thereby mistakenly accepting the MAC ID and reverse link timing information in the access grant message.

To avoid this erroneous behavior, according to yet another aspect of the present invention, the access network scrambles an access grant message that is in response to the first type of access probe with a scrambling sequence that is generated from the access sequence ID detected from the first type of access probe. Meanwhile, the access network scrambles an access grant message that is in response to a second type of access probe with a special scrambling sequence that is different from any scrambling sequence used on the access grant message in response to a first type of access grant.

Furthermore, the access network places the regular MAC ID, which is detected from the second type of access probe, into the MAC ID field in the access grant message that is in response to the corresponding second type of access probe. This special scrambling sequence for the access grant message can be generated from a special access sequence ID, no matter what access sequence ID is detected from this second type of access probe. In this case, the special access sequence ID and the corresponding access sequence are reserved and cannot be used by any mobile station for sending the first type of access probe. Alternatively, this special scrambling sequence for the access grant message can be generated from a special scrambling sequence generation formula. In either case, this special scrambling sequence for the access grant message is known to both the access network and the mobile stations by standard default or by an explicit signaling message broadcasted by the access network. The access network differentiates the type of access probe by the scrambling sequence applied on the access probe.

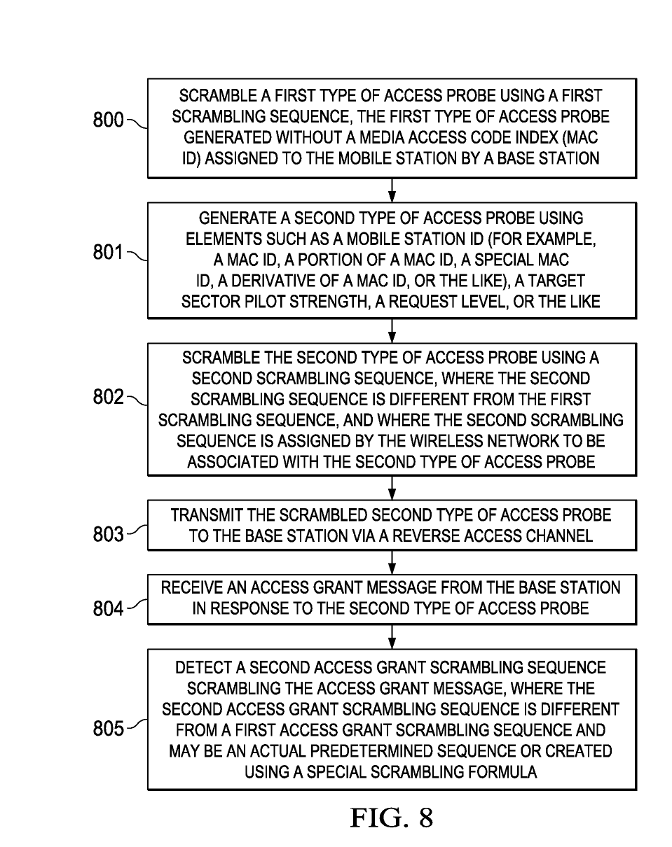

FIG. 8 is a flowchart illustrating example steps executed to implement one embodiment of the present invention. In step 800, a first type of access probe is scrambled using a first scrambling sequence, the first type of access probe generated without a MAC ID assigned to the mobile station by a base station. A second type of access probe is generated, in step 801, using elements such as a mobile station ID (for example, a MAC ID, a portion of a MAC ID, a special MAC ID, a derivative of a MAC ID, or the like), a target sector pilot strength, a request level, or the like. The second type of access probe is scrambled, in step 802, using a second scrambling sequence, where the second scrambling sequence is different from the first scrambling sequence, and where the second scrambling sequence is assigned by the wireless network to be associated with the second type of access probe. In step 803, the scrambled second type of access probe is transmitted to the base station via a reverse access channel. An access grant message is received from the base station, in step 804, in response to the second type of access probe. In step 805, a second access grant scrambling sequence is detected scrambling the access grant message, where the second access grant scrambling sequence is different from a first access grant scrambling sequence, which is used to scramble the access grant message that is sent in response to a first type of access probe, and may be an actual predetermined sequence or created using a special scrambling formula.

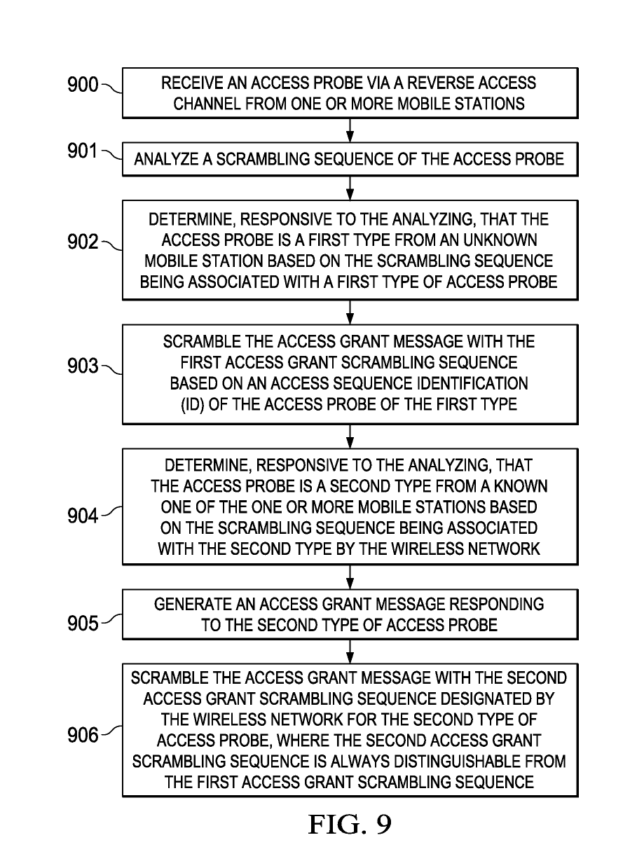

FIG. 9 is a flowchart illustrating example steps executed to implement one embodiment of the present invention. In step 900, an access probe is received via a reverse access channel from one or more mobile stations. A scrambling sequence of the access probe is analyzed in step 901. In step 902, a determination is made, responsive to the analysis, that the access probe is a first type from an unknown mobile station based on the scrambling sequence being associated with a first type of access probe. An access grant message is then scrambled, in step 903, with the first access grant scrambling sequence based on an access sequence identification (ID) of the access probe of the first type. Responsive to the analysis, a determination is made, in step 904, that the access probe is a second type from a known one of the one or more mobile stations based on the scrambling sequence being associated with the second type by the wireless network. An access grant message is generated, in step 905, responding to the second type of access probe. The access grant message is then scrambled, in step 906, with the second access grant scrambling sequence designated by the wireless network for the second type of access probe, where the second access grant scrambling sequence is always distinguishable from the first access grant scrambling sequence.

The various illustrative logical blocks, modules, and circuits described in connection with the embodiment disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

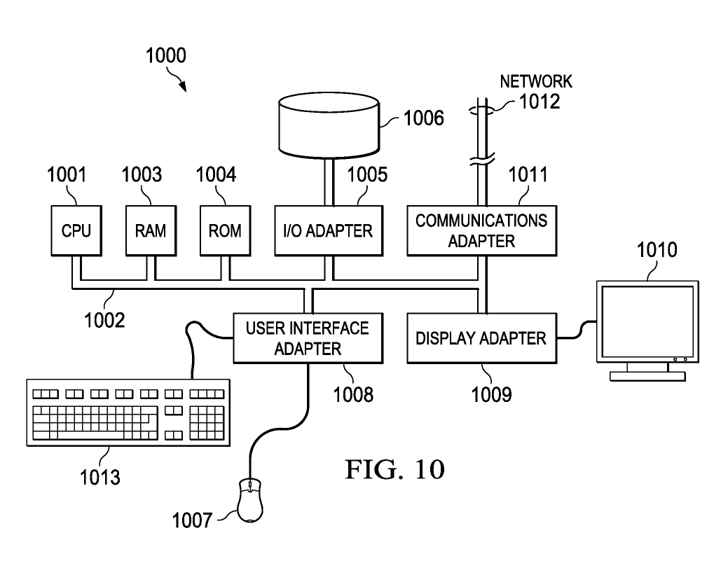

FIG. 10 illustrates computer system 1000 adapted to use embodiments of the present invention, e.g., storing and/or executing software associated with the embodiments. Central processing unit (CPU) 1001 is coupled to system bus 1002. CPU 1001 may be any general purpose CPU. However, embodiments of the present invention are not restricted by the architecture of CPU 1001 as long as CPU 1001 supports the inventive operations as described herein. Bus 1002 is coupled to random access memory (RAM) 1003, which may be SRAM, DRAM, or SDRAM. ROM 1004 is also coupled to bus 1002, which may be PROM, EPROM, or EEPROM. RAM 1003 and ROM 1004 hold user and system data and programs as is well known in the art.

Bus 1002 is also coupled to input/output (I/O) adapter 1005, communications adapter 1011, user interface adapter 1008, and display adapter 1009. I/O adapter 1005 connects storage devices 1006, such as one or more of a hard drive, a CD drive, a floppy disk drive, and a tape drive, to computer system 1000. I/O adapter 1005 is also connected to a printer (not shown), which would allow the system to print paper copies of information such as documents, photographs, articles, and the like. Note that the printer may be a printer (e.g., dot matrix, laser, and the like), a fax machine, a scanner, or a copier machine.

The steps of a method or algorithm described in connection with the embodiments disclosed herein may be implemented or performed directly in hardware, in a software module executed by a processor, or in combination of the two. A software module may reside in RAM memory, flash memory, ROM memory, EPROM memory, EEPROM memory, registers, or any other form of storage medium in the art.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method executed by a mobile station in a wireless network, said method comprising:
scrambling a first type of access probe using a first scrambling sequence, said first type of access probe generated without a media access code index (MAC ID) assigned to said mobile station by a base station;
scrambling a second type of access probe using a second scrambling sequence, wherein said second scrambling sequence is different from said first scrambling sequence, and wherein said second scrambling sequence is assigned by said wireless network to be associated with said second type of access probe; and
transmitting said scrambled second type of access probe to said base station via a reverse access channel.

2. The method of claim 1, further comprising:
generating said second type of access probe, said generating including:
inserting a mobile station identifier into said second type of access probe;
measuring a strength level of a target sector pilot; and
inserting said strength level into said second type of access probe.

3. The method of claim 2 wherein said generating further comprises:
inserting a request level into said second type of access probe.

4. The method of claim 2 wherein said mobile station identifier comprises one of:
said MAC ID;
a portion of said MAC ID;
a special MAC ID; or
a derivative of said MAC ID.

5. The method of claim 1 further comprising:
receiving an access grant message from said base station in response to said second type of access probe;
detecting a second access grant scrambling sequence scrambling said access grant message, wherein said second access grant scrambling sequence is different from a first access grant scrambling sequence, said first access grant scrambling sequence for scrambling a first type of access grant message that is sent in response to said first type of access probe; and
responsive to said detecting, determining said access grant message is in response to said transmitting.

6. The method of claim 5 wherein said second access grant scrambling sequence is generated by said base station using a special scrambling formula that is different from a scrambling formula used to generate said first access grant scrambling sequence.

7. A method executed by one or more base stations in a wireless network, said method comprising:
receiving an access probe via a reverse access channel from one or more mobile stations;
analyzing a scrambling sequence of said access probe;
responsive to said analyzing, determining said access probe is a second type from a known one of said one or more mobile stations based on said scrambling sequence being associated with said second type by said wireless network;
generating an access grant message responding to said access probe; and
scrambling said access grant message with a second access grant scrambling sequence designated by said wireless network for said second type of access probe.

8. The method of claim 7 further comprising:
responsive to said analyzing, determining said access probe is a first type from an unknown mobile station based on said scrambling sequence being associated with a first type of access probe.

9. The method of claim 8 further comprising:
scrambling said access grant message with a first access grant scrambling sequence based on an access sequence identification (ID) of said access probe of a first type, wherein said second access grant scrambling sequence is always distinguishable from said first access grant scrambling sequence.

10. A wireless network comprising:
one or more base stations;
a plurality of mobile stations connected to said one or more base stations;
a reverse access channel facilitating communication initiated by ones of said plurality of mobile stations and one of said one or more base stations;
a second type access probe generated by one of said plurality of mobile stations to communicate with one of an active set of said one or more base stations, wherein each base station of said active set has already assigned a media access control index (MAC ID) to said one of said plurality of mobile stations;
a second type scrambling sequence assigned by said wireless network to scramble said second type access probe; and
a second type access grant message generated by one of said one or more base stations, wherein said second type access grant message responds to said second type access probe, and wherein said second type access grant message is scrambled according to a second access grant scrambling sequence.

11. The wireless network of claim 10 further comprising:
a first type access probe message generated by others of said plurality of mobile stations, wherein said others of said plurality of mobile stations have not been assigned a MAC ID by said one or more base stations; and
a first type scrambling sequence to scramble said first type access probe message, wherein said first type scrambling sequence is distinguishable by said one or more base stations from said second type scrambling sequence.

12. The wireless network of claim 10 wherein said second type access probe comprises one or more of:
a wireless station identifier;
a target sector pilot strength; and
a request level.

13. The wireless network of claim 12 wherein said wireless station identifier comprises one of:
said MAC ID;
a portion of said MAC ID;
a special MAC ID that is different from said MAC ID; and
a derivative of said MAC ID.

14. A computer program product having a computer readable medium with computer program logic recorded thereon, said computer program product comprising:
code for scrambling a first type of access probe using a first scrambling sequence, said first type of access probe generated without a media access code index (MAC ID) assigned to a mobile station by a base station in a wireless network;
code for scrambling a second type of access probe using a second scrambling sequence, wherein said second scrambling sequence is different from said first scrambling sequence, and wherein said second scrambling sequence is assigned by said wireless network to be associated with said second type of access probe; and
code for transmitting said scrambled second type of access probe to said base station via a reverse access channel.

15. The computer program product of claim 14, further comprising:
code for generating said second type of access probe, said code for generating including:
code for inserting a mobile station identifier into said second type of access probe;
code for initiating measurement of a strength level of a target sector pilot by said mobile station; and
code for inserting said strength level into said second type of access probe.

16. The computer program product of claim 15 wherein said code for generating further comprises:
code for inserting a request level into said second type of access probe.

17. The computer program product of claim 15 wherein said mobile station identifier comprises one of:
said MAC ID;
a portion of said MAC ID;
a special MAC ID; or
a derivative of said MAC ID.

18. The computer program product of claim 14 further comprising:
code for receiving an access grant message from said base station;
code for detecting a second access grant scrambling sequence scrambling said access grant message that is sent in response to said second type of access probe, wherein said second access grant scrambling sequence is different from a first access grant scrambling sequence, said first access grant scrambling sequence used to scramble a first type of access grant message that is sent in response to said first type of access probe; and
responsive to results of said code for detecting, code for determining said access grant message is in response to results of said code for transmitting.

19. The computer program product of claim 18 wherein said second access grant scrambling sequence is generated by said base station using a special scrambling formula that is different from a scrambling formula used to generate said first access grant scrambling sequence.

20. A computer program product having a computer readable medium with computer program logic recorded thereon, said computer program product comprising:
code for receiving an access probe by one or more base stations via a reverse access channel from one or more mobile stations;
code for analyzing a scrambling sequence of said access probe;
responsive to results of said code for analyzing, code for determining said access probe is a second type from a known one of said one or more mobile stations based on said scrambling sequence being associated with said second type by a wireless network;
code for generating an access grant message responding to said access probe; and
code for scrambling said access grant message with a second access grant scrambling sequence designated by said wireless network for said second type of access probe.

21. The computer program product of claim 20 further comprising:
responsive to results of said code for analyzing, code for determining said access probe is a first type from an unknown mobile station based on said scrambling sequence being associated with a first type of access probe.

22. The computer program product of claim 21 further comprising:
code for scrambling said access grant message with a first access grant scrambling sequence based on an access sequence identification (ID) of said access probe of a first type, wherein said first access grant scrambling sequence is always distinguishable from said second access grant scrambling sequence.

23. A method for a rake receiver comprising:
removing one or more cyclic prefixes (CPs) from an incoming baseband signal;
converting said CP-removed baseband signal from serial to parallel format;
performing discrete Fourier transform (DFT) to convert said parallel formatted signal from time domain to frequency domain;
de-channelizing said converted signal into an input signal;
separating data channel signals and control channel signals from said input signal;
performing inverse DFT (IDFT) to reconvert said control channel signals from frequency domain to time domain;
generating a plurality of cyclic shifted versions of said reconverted control channel signals after said removing, said converting, said de-channelizing, and said performing IDFT;
correlating each of said plurality of cyclic shifted versions to a plurality of Walsh codes; and
determining one or more Walsh code indexes to represent transmitted information bits based on results of said correlating.

24. The method of claim 23 wherein said correlating includes:
demodulating each of said plurality of cyclic shifted versions; and
descrambling each of said demodulated plurality of cyclic shifted versions.

25. The method of claim 24 wherein said correlating further includes:
applying a Hadamard transform to each of said descrambled plurality of cyclic shifted versions.

26. The method of claim 23 wherein said determining includes:
combining said results of said correlating between each of said plurality of cyclic shifted versions with a same Walsh code for each of said plurality of Walsh codes.

27. The method of claim 26, wherein said results of correlating comprise correlation energies.

28. A rake receiver comprising:
a discrete Fourier transform (DFT) module at an input to said rake receiver;
a channel separator connected to said DFT module to separate data channel signals and control channel signals from an incoming signal;
an inverse DFT (IDFT) module connected to an output of said channel separator;
a cyclic shift rotator connected to said IDFT module for generating a plurality of cyclic shifted versions of said control channel signals;
a plurality of correlators connected to said cyclic shift rotator, wherein each of said plurality of cyclic shifted versions is processed through a corresponding one of said plurality of correlators; and
an energy detector connected to each of said plurality of correlators, wherein said energy detector combines correlation energies between said plurality of cyclic shifted versions after correlation with a same code for each of a plurality of codes.

29. The rake receiver of claim 28 wherein said plurality of codes comprises a plurality of Walsh codes.

30. The rake receiver of claim 29 wherein each of said plurality of correlators comprises:
a demodulator;
a descrambler; and
a Hadamard transform module.

31. A computer program product having a computer readable medium with computer program logic recorded thereon, said computer program product comprising:
code for removing one or more cyclic prefixes (CPs) from an incoming baseband signal;
code for converting said CP-removed baseband signal from serial to parallel format;
code for performing discrete Fourier transform (DFT) to convert the parallel formatted signal from time domain to frequency domain;
code for de-channelizing said converted signal into an input signal;
code for separating data channel signals and control channel signals from said input signal;
code for performing inverse DFT (IDFT) to reconvert said control channel signals from frequency domain to time domain;
code for generating a plurality of cyclic shifted versions of said reconverted control channel signals after execution of said code for removing, said code for converting, said code for de-channelizing, and said code for performing IDFT;
code for correlating each of said plurality of cyclic shifted versions to a plurality of Walsh codes; and
code for determining one or more Walsh code indexes to represent transmitted information bits based on results of said correlating.

32. The computer program product of claim 31 wherein said code for correlating includes:
code for demodulating each of said plurality of cyclic shifted versions; and
code for descrambling each of said demodulated plurality of cyclic shifted versions.

33. The computer program product of claim 32 wherein said code for correlating further includes:
code for applying a Hadamard transform to each of said descrambled plurality of cyclic shifted versions.

34. The computer program product of claim 33 wherein said code for determining further includes:
code for combining correlation energies of said plurality of cyclic shifted versions with a same Walsh code for each of said plurality of Walsh codes.
